(19) United States
(12) Patent Application Publication
(10) Pub. No.: US 2025/0381094 A1
(43) Pub. Date: Dec. 18, 2025

(54) VIBRATORY STIMULATION DEVICE

(71) Applicant: Lloyd Reid, Bronx, NY (US)

(72) Inventor: Lloyd Reid, Bronx, NY (US)

(21) Appl. No.: 19/303,484

(22) Filed: Aug. 19, 2025

Related U.S. Application Data
(63) Continuation-in-part of application No. PCT/US2024/016470, filed on Feb. 20, 2024.
(60) Provisional application No. 63/446,887, filed on Feb. 19, 2023.

(51) Int. Cl. A61H 19/00; A61H 9/00; A61H 23/02; G10H 1/00; H04R 1/02

(52) U.S. Cl. CPC A61H 19/44; A61H 9/0057; A61H 23/0245; A61H 23/0254; G10H 1/0008; H04R 1/028; A61H 2201/1246; A61H 2201/5005; A61H 2201/5012; A61H 2201/5048; G10H 2210/076

(57) ABSTRACT

A vibratory stimulation device is provided that includes a housing including a skin contacting region. A drive unit is enclosed within the housing, the drive unit is configured to generate vibrations. A control device in electrical communication with the drive unit is configured to control the vibrations generated by the drive unit based on vibratory pattern data. The vibratory pattern data corresponds to a set of audio data. A method for programming the vibratory stimulation device includes converting a set of audio data into vibratory pattern data that is input into a memory of the control device. A business method is also provided for sale of the device at a performance venue at which the artist is about to or has just performed the song or the album.

### RELATED APPLICATIONS

This application is a Continuation-in-Part of, and claims priority benefit of Patent Cooperation Treaty Application Number PCT/US24/16470 filed Feb. 20, 2024, which in turn claims priority benefit of U.S. Provisional Application Ser. No. 63/446,887 filed Feb. 19, 2023; the contents of which are hereby incorporated by reference.

### FIELD OF THE INVENTION

The present invention relates to a vibratory stimulation device for stimulating body parts with vibrations, particularly erogenous zones of the human body. More particularly, it relates to a vibratory stimulation device which produces vibrations transformed from a sound signal, such as song or an album of songs.

### BACKGROUND OF THE INVENTION

The erogenous zones of the human body can be stimulated with a variety of tools. For example, vibratory devices are used to apply a stimulus to a particular area of the skin. As current technology of stimulating the human body using vibration, various methods are applied and utilized, for example, a linear stimulating method using a simple rotary vibration motor and a solenoid, a pressing method of using air pressure, a stimulator inducing muscle contraction by inputting low-frequency current, and a method of contracting the muscle using a magnetic field. However, the above-mentioned methods simply apply pressure or stimulation to the human body, and have technical limits.

For example, a vibratory device using a motor may adjust the number of vibrations, but is problematic in that it is impossible to adjust an amplitude or an intensity thereof, so it may be rhythmically limited and not transmit the desired number of vibrations due to the structural characteristics thereof. While smart phone control of such a device has been contemplated this has met with limited acceptance owing to technical complexity.

Vibratory devices increasingly incorporate audio and vibration features to enhance user experience. While vibration-based devices are commonly used, there remains a need for synchronized multisensory stimulation that dynamically maps audio-especially music-to both vibration and suction feedback in real time. No known device integrates suction feedback controlled by music characteristics while playing the audio through an onboard speaker or memory module.

Thus, there exists a need for a multisensory stimulation device that provides a unique vibratory and/or suction stimulation experience with a wider array of suction pulses and vibrations outputs based on characteristics of audio content detected in real time. There also exists a need for enhanced marketing opportunities for musical artists to provide their music in a way that can be experienced by users of a multisensory stimulation device.

### SUMMARY OF THE INVENTION

A vibratory stimulation device is provided that includes a housing including a skin contacting region. A drive unit is enclosed within the housing, the drive unit is configured to generate vibrations that are transmitted to the skin contacting region of the housing. A control device enclosed within the housing, the control device in electrical communication with the drive unit and configured to control the vibrations generated by the drive unit based vibratory pattern data that is stored on a memory of the control device. The vibratory pattern data corresponds to a set of audio data.

A method for programming the vibratory stimulation device includes converting a set of audio data into vibratory pattern data. The vibratory pattern data is input into the memory of the control device, the vibratory pattern data includes intensity, rhythm, frequency, and modulation of vibrations to be generated by the drive unit and transmitted to the skin contacting region of the housing.

A business method is also provided that includes the conversion of a song or an album of an artist into a square wave pattern. The square wave pattern is loaded into an internal memory of the vibratory stimulation device. The vibratory stimulation device is sold at a performance venue at which the artist is about to or has just performed the song or the album.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a cross-sectional view of a vibratory stimulation device according to embodiments of the present invention;

FIG. 2 is a block diagram of an embodiment of the present invention;

FIG. 3 shows a kit containing components of an embodiment of an inventive device; and

FIG. 4 is an assembled form of the inventive device of FIG. 3.

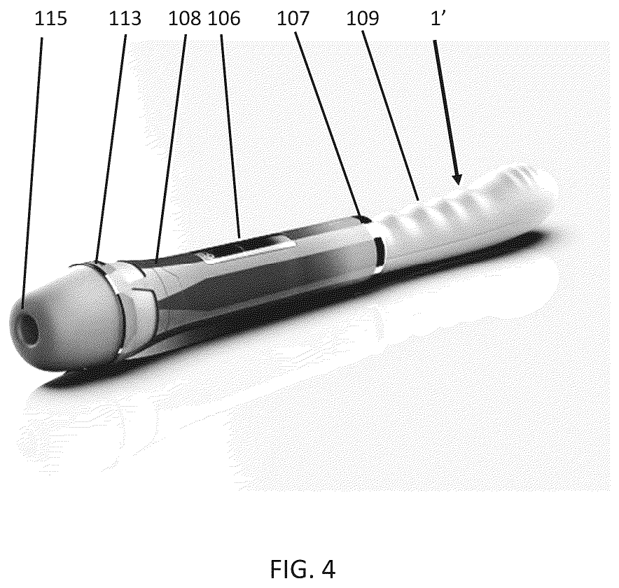

### DETAILED DESCRIPTION OF THE INVENTION

The present invention has utility as a multisensory stimulation device that provides a unique vibratory and/or suction stimulation experience with a wider array of suction pulses and vibrations outputs based on characteristics of audio content detected in real time. The device provides a unique vibratory and suction stimulation experience with a wider array of rhythms, suction pulses, and vibrations based on music from a particular musical artist. The present invention thus provides for synchronized multisensory stimulation that dynamically maps audio—especially music—to both vibration and suction feedback in real time. In particular, such vibratory patterns are formed as a square wave pattern based a transformation of the auditory signal of a song or other non-periodic input. In some inventive embodiments, the square wave vibratory pattern corresponding to the stimulation is programmed internally into the device. Thus, the present invention additionally provides for enhanced marketing opportunities for musical artists to provide their music in a way that can be experienced by users of a vibratory stimulation device.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

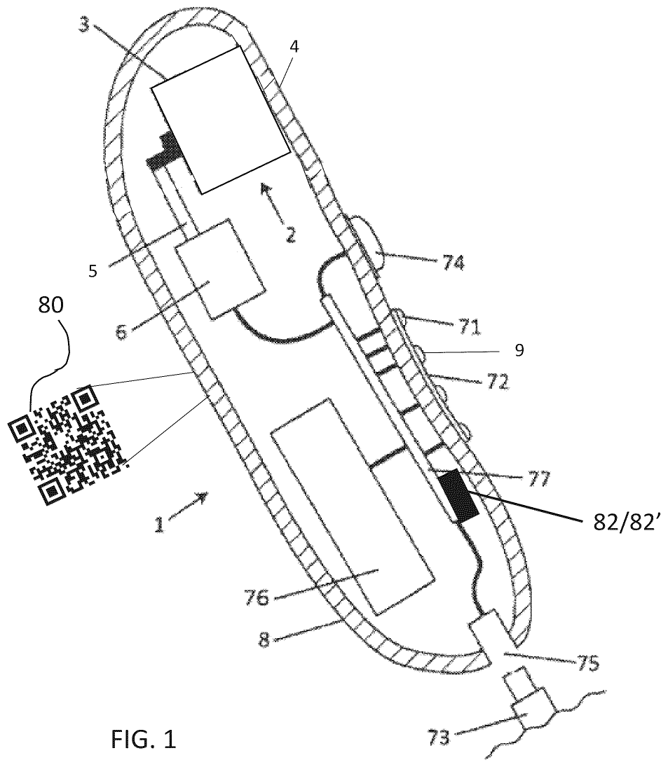

According to embodiments, the vibratory stimulation device 1 is a preferably electric or small device, comprising a housing 8, a vibration generator 2, operating elements 71, a display 72, an on/off switch 74, a socket 75, an optional battery 76 and optional lighting 9. Notably, while FIG. 1 shows a cross sectional view of a vibratory stimulation device, it is to be understood that the present invention is not intended to be tied to any particular shape or configuration of the vibratory stimulation device. Rather, the inventive concepts disclosed herein are intended to be applicable to vibratory stimulation devices of various shapes, sizes, configurations and those equipped with various features. It is appreciated that a device according to the present invention is readily configured as any one of a rose, a dildo, a rabbit, a clitoral vibrator, an anal toy, vibrating panties, a wireless remote control vibrator, a hammer, a nipple toy, a wand, or a bullet. Furthermore, it will be understood that according to embodiments, the above listed elements of the device 1 may be provided within a single unit or in multiple units, such as a control unit and a separate stimulation unit.

Housing 8 is preferably designed ergonomically so that it can be held comfortably in one hand and has no sharp or pointed edges. Furthermore, housing 8 may consist of plastic, such as polycarbonate (PC) or acrylonitrile butadiene styrene (ABS). In addition, the gripping areas or even the entire housing may be supplemented by or designed in a haptically advantageous silicone. Housing 8 is preferably designed to be at least water-resistant or splash-proof. According to embodiments, the housing 8 includes a QR code 80 formed thereon that may be linked to information about the device or the particular musical artist associated with the music upon which the vibratory stimulations of the particular device are tied. The QR code 80 may also link to a merchandise website of that particular musical artist so that a user of the vibratory stimulation device may quickly and easily purchase other products associated with that musician in general, and in particular the soundtrack corresponding to the vibratory pattern data internal to the device. As a result, a user can play a given song through a smartphone or tablet device used to download the soundtrack via the QR code 80 and in some inventive embodiments play the audio song in synchronicity with operation of the corresponding vibratory pattern of the device 1.

Operating elements 71 are used to adjust the device operating mode, i.e. to adjust the intensity of the vibratory stimulation or to advance to the next pattern of vibration based on a song on a given album. Operating elements 71 can, for example, be designed as at least one pushbutton, as at least one rotary switch, or as at least one touch-sensitive switch. Furthermore, operating elements 71 can produce an optical feedback for activating light emitting diodes (LED) integrated in the center of the switch, for example.

An optional display 72 serves to inform the user of the device status and/or the setting status. Display 72 can for example be configured as a plurality of light diodes or as an LCD display. The displayed information can, for example, be the charge status of an optional battery, the current setting of the modulation pattern, or the song name associated with a particular vibratory stimulation pattern.

On/off switch 74 is used for activating and deactivating vibratory stimulation device 1. This on/off switch 74 can, for example, be a pushbutton, which switches vibratory stimulation device 1 on or off when held down, or a ratcheting slide switch.

A socket 75 is used to supply the external power of vibratory stimulation device 1 via an external plug 73, which is connected to an external power adapter, for example. To ensure vibratory stimulation device 1 is splash-proof, a magnetic-inductive transformer may be provided instead of the socket, which allows power to be transmitted to vibratory stimulation device 1 without any electroconductive contact. Vibratory stimulation device 1 preferably also has a battery 76, such as a nickel metal hydride battery (NiMH) for wireless operation. According to embodiments, the socket 75 is also or alternatively used to program the vibratory stimulation device 1 with a vibratory square wave signal that corresponds to a song or even a musical album upon which the vibratory stimulation pattern is based. According to embodiments, there is a second port provided for programing the vibratory stimulation device 1 with a musical album upon which the vibratory stimulation pattern is based.

Optional lighting 9 is provided on or in housing 8. Lighting 9 can either be switched by the user or automatically activated by activating vibratory stimulation device 1. Furthermore, lighting 9 can be composed of energy-saving light diodes. The lighting can, for example, serve as an orientation aid in the dark for the user of vibratory stimulation device 1 or as additional optical stimulation.

The vibration generator 2 includes a drive unit 6 positioned within the interior of vibratory stimulation device 1 and an unbalanced mass or piezoelectric element 3 on a connection element 5. The drive unit 6, such as an electric motor, drives an unbalanced mass or piezoelectric element 3 via the connection element 5, such as a driveshaft. The vibrations generated by the operation of the drive unit 6 and its unbalanced mass or piezoelectric element 3 are transmitted to a skin contacting region 4 of the housing 8 for application to the body part to be stimulated. According to other embodiments, the vibration generator is any haptic mechanism e.g., spinning motor, servo motor, vibrator, etc., can be utilized to facilitate haptic feedback, such as vibration, force, and/or motions. It is appreciated that a piezoelectric device operates with an electrical input and does not requires mechanical energy transfer components such as a driveshaft.

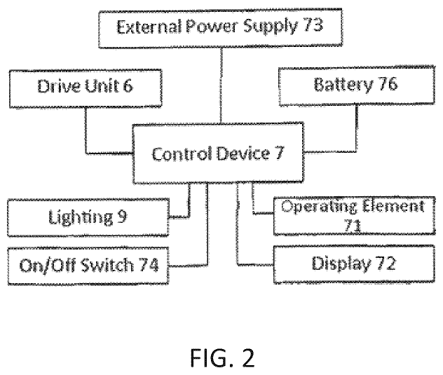

A control device 7 activates drive unit 6, operating elements 71 and display 72. Control device 7 and drive unit 6 are supplied with power by internal battery 76 and/or external power supply 73. FIG. 2 shows a block diagram of an example of the functional construction of an embodiment with a control device 7, a drive unit 6, lighting 9, an on/off switch 74, operating elements 71, a battery 76 and an external power supply 73.

Control device 7, which has a microcontroller or is hardwired, for example, controls the power supply and vibratory stimulation pattern of the vibratory stimulation device 1, as well as an optional charging and discharging process of battery 76 and/or a battery management. In particular, control device 7 controls the vibratory stimulation pattern of drive unit 6, such as the, intensity, rhythm, frequency, modulation, etc.

Furthermore, the control device 7 has a non-volatile memory 82 in which at least one modulation or stimulation pattern is saved. The memory stores the vibratory stimulation patterns of the vibratory stimulation device 1. As a result, an inventive device 1, in some inventive embodiments is akin to a music album has a static loading of vibratory pattern data corresponding to the audio soundtrack of the music album and as a result cannot be updated with new vibratory data after manufacture unless the memory 82 is exchanged with a new memory 82′. In some inventive embodiments, a seam or access door is provide in the housing 8 to allow for exchange of the memory 82 by memory 82′ that varies in terms of vibratory pattern data. As mentioned above, the vibratory patterns of the vibratory stimulation device are based on music. According to embodiments, a set of music, such as an album worth or concert worth of songs are input into the memory of the vibratory stimulation device 1. A processor of the device that is typically integral with the memory 82 then converts the music data into vibratory stimulation pattern data which is then output from the vibratory stimulation device as vibrations. According to other embodiments, the conversion of the music data into vibratory stimulation patters takes place outside of the vibratory stimulation device 1, for example on a computer. Subsequently, the data of vibratory stimulation patterns is then input to the memory of the vibratory stimulation device, which is then output from the vibratory stimulation device as vibrations. Any method of converting audio data, such as music, into vibration data may be utilized, according to embodiments of the present invention, such as that disclosed in U.S. Pat. No. 9,083,821, U.S. application Ser. No. 17/567,357, or U.S. Pat. No. 10,812,914, which are hereby incorporated by reference.

Once the vibration stimulation pattern data has been stored onto the memory of the vibratory stimulation device 1, the excitation of drive unit 6 can be activated via operating elements 71 to control the device 1 for outputting a vibratory stimulation pattern at the discretion of the user of vibratory stimulation device 1.

Notably, the vibratory stimulation device 1 does not include a speaker or other audio output. Instead, the output is in the form of vibratory patterns only. Additionally, the memory 82 of the vibratory stimulation device 1 is not configured to be rewriteable or programmable by a user of the vibratory stimulation device. Instead, the device 1 is configured to be programed with audio data or vibration pattern data only once. Thus, the vibratory stimulation device 1 will only ever output the vibration pattern data associated with a particular audio data set from a given album or concert as dictated by the seller of the vibratory stimulation device 1. As such the vibratory stimulation device 1 becomes a useful marketing tool for a particular artist. An additional method operative to convert music to square wave format operative herein to drive a vibratory stimulation device 1 is detailed in S. Osvaldo et al. “A New Method For The Analysis Of Signals: The Square-Wave Method.” Revista de Matemática: Teoría y Aplicaciones 15.2 (2008): 109-129.

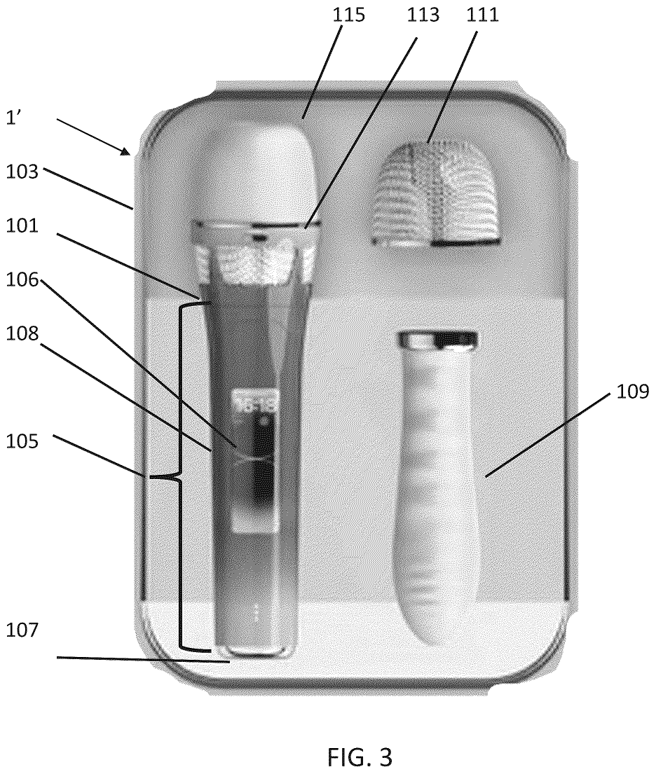

In still other embodiments, an inventive device l′ is varies from device 1 of FIG. 1 in the inclusion of a speaker 101 that simultaneously provides the audio data as an auditory sound from a portion that is not skin contacting 105. In some inventive embodiments, a volume control control 106 is provided under a plastic wrap 108. The portion 105 has a coupling surface 107 to engage a vibratory device portion 109 that includes all the functionality of device 1. The coupling between surface 107 and the portion 109 illustratively includes threads, or a bayonet fitting. A mesh cover 111 is provided that adapted to couple to an auditory emitting end 113 of the device 1′. An apertured elastomeric cover 115 is provided to protect the mesh cover 111. The device 1′ being amenable to disassembly to facilitate cleaning and storage. A case 103 encloses the components of the device l′ as shown in FIG. 3. The device l′

According to embodiments, the device 1 is a multisensory stimulation device comprising a processor configured to analyze musical characteristics of audio content in real time and control both vibration and suction outputs based on the detected rhythm, beat, and amplitude of the music. The suction module is configured to pulse or vary pressure synchronized with the beat of the music, while a vibration actuator simultaneously delivers music-synced vibration. The device includes embedded music or streaming capabilities, enabling dynamic stimulation choreographed to live or prerecorded songs. The device also optionally functions in standalone vibration or suction mode without audio input. According to embodiments, the device 1 provides a synchronized multisensory stimulation that dynamically maps audio-especially music-to both vibration and suction feedback in real time. According to embodiments, the device 1 provides a music-responsive stimulation device that utilizes both suction and vibration outputs controlled by the same real-time audio input. The device analyzes characteristics such as beat, amplitude, frequency, and rhythm, and maps those to control patterns in a suction module and a vibration actuator. According to embodiments, the user can select suction-only, vibration-only, or dual-mode operation. The device may play embedded music or receive streaming content. The suction feedback pulses in sync with the detected beats, while vibration follows amplitude or tempo for immersive sensory stimulation. According to embodiments, the device 1 described above additionally includes a memory unit storing audio tracks, a speaker, a processor for analyzing music signals, a vibration motor, and a suction module. The processor continuously analyzes the beat and amplitude of the audio signal. The suction module, including a pump or vacuum chamber, varies pressure in response to beat detection. Suction pulses may align with each beat or dynamically scale with volume. The vibration motor produces a complementary waveform-mapped pattern. The system optionally allows standalone operation without music, providing constant or user-defined suction and vibration modes. The device may include buttons or a mobile interface to switch between modes and set intensity.

In an inventive business method, an inventive vibratory stimulation device is sold at a performance venue at which the artist is about to, or has just performed the song or the album stored in the memory thereof.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A vibratory stimulation device comprising:
a housing including a skin contacting region;
a drive unit enclosed within the housing, the drive unit configured to generate vibrations that are transmitted to the skin contacting region of the housing;
a control device in electrical communication with the drive unit and configured to control the vibrations generated by the drive unit based on vibratory pattern data;
wherein the vibratory pattern data corresponds to a set of audio data.

2. The vibratory stimulation device of claim 1 wherein the vibratory stimulation device has a configuration of a rose, a dildo, a rabbit, a clitoral vibrator, an anal toy, vibrating panties, a wireless remote control vibrator, a hammer, a nipple toy, a wand, or a bullet.

3. The vibratory stimulation device of claim 1 further comprising a power source configured to provide electrical power to the drive unit and the control device.

4. The vibratory stimulation device of claim 1 wherein the housing defines a port configured to electrically connect a power source of the device with an external power supply or the port is configured to input audio data or vibratory pattern data to a memory of the control device.

5. The vibratory stimulation device of claim 1 wherein the housing includes a QR code positioned on an exterior surface thereof.

6. The vibratory stimulation device of claim 1 further comprising at least one operating element in electrical communication with the control device and configured to transmit user control input to the control device.

7. The vibratory stimulation device of claim 6 wherein the at least one operating element includes an on/off button, is configured to adjust an operating mode of the device or is any of a pushbutton, a rotary switch, a touch-sensitive switch, or a combination thereof.

8. The vibratory stimulation device of claim 1 further comprising a display in electrical communication with the control device, the display configured to display information regarding any of a charge status, a current setting of the device, a song name associated with the vibratory pattern data, or a combination thereof.

9. The vibratory stimulation device of claim 1 wherein the drive unit includes a motor, a connection element extending from the motor, and an unbalanced mass attached to an end of the connection element that is remote from the motor or is an electrically driven piezoelectric device.

10. The vibratory stimulation device of claim 1 wherein the set of audio data is a plurality of songs.

11. The vibratory stimulation device of claim 1 wherein the vibratory pattern data includes intensity, rhythm, frequency, and modulation of the vibrations generated by the drive unit.

12. The vibratory stimulation device of claim 1 further comprising a speaker configured to be exterior to the skin contacting region that simultaneously plays the auditory data.

13. A method for programming a vibratory stimulation device of claim 1, the method comprising:
converting a set of audio data into vibratory pattern data; and
communicating the vibratory pattern data from the control device to the drive unit;
wherein the vibratory pattern data includes intensity, rhythm, frequency, and modulation of vibrations based on characteristics of audio content to be generated by the drive unit and transmitted to the skin contacting region of the housing.

14. A music-responsive stimulation device comprising:
a memory configured to store or stream audio content;
a speaker or audio output module to play the audio during operation;
a processor configured to analyze audio features including beat, tempo, and amplitude;
a vibration actuator configured to produce a vibration pattern synchronized with said audio features;
a suction module configured to modulate suction pressure in synchronization with the beat of the music;
a user interface to enable one or both outputs simultaneously;
wherein the suction and vibration outputs are generated concurrently and dynamically in real-time based on the same audio input.

15. The device of claim 14, wherein the suction module comprises a diaphragm pump or vacuum actuator.

16. The device of claim 15, wherein the processor includes beat-detection logic and waveform segmentation to trigger suction pulses.

17. The device of claim 15, wherein the suction intensity varies in real-time based on the amplitude of the audio signal.

18. The device of claim 15, wherein the vibration and suction modules operate in standalone or synchronized mode as selected by the user.

19. The device of claim 15, wherein the audio comprises embedded audio files stored in the memory.

20. The device of claim 15, wherein the processor allows mapping suction pulses to detected beats within a threshold delay of less than 50 milliseconds.
